(19) United States
(12) Patent Application Publication
(10) Pub. No.: US 2017/0237692 A1
(43) Pub. Date: Aug. 17, 2017

(54) STRUCTURED CHAT MESSAGING FOR INTERACTION WITH BOTS

(71) Applicant: GupShup Inc, Fremont, CA (US)

(72) Inventors: Beerud Dilip SHETH, Fremont, CA (US); Nirmesh MEHTA, Fremont, CA (US)

(21) Appl. No.: 15/581,941

(22) Filed: Apr. 28, 2017

Related U.S. Application Data
(63) Continuation-in-part of application No. 14/607,876, filed on Jan. 28, 2015, now abandoned.
(60) Provisional application No. 61/932,537, filed on Jan. 28, 2014.

(51) Int. Cl. H04L 12/58; G06F 17/30; H04W 4/06

(52) U.S. Cl. CPC H04L 51/02; H04L 51/18; H04W 4/06; G06F 17/30398; G06Q 30/0201

(57) ABSTRACT

Disclosed is a method and system for structured chat messaging between user devices and bots. The method comprises creating a structured chat message by a bot of a user group, wherein the user group consist of one or more user devices and one or more bots, wherein the structured chat message comprises one or more data fields, and wherein the structured chat message comprises layout metadata defining a representation of the structured chat message; sending the structured chat message to the user group, by the bot; and facilitation to display the structured chat message on the user devices using the layout metadata; defining a message handler for the structured chat message; accepting inputs for the one or more data fields from users present in the user group; updating the structured chat message using the message handler based on the inputs of the users.

### CROSS-REFERENCE TO RELATED APPLICATIONS AND PRIORITY

The present application is a continuation-in-part of and claims priority from U.S. patent application Ser. No. 14/607,876 titled “CHAT MESSAGING”, filed on Jan. 28, 2015, which claims priority from U.S. Provisional Patent Application No. 61/932,537, filed on Jan. 28, 2014, the entirety of which is hereby incorporated by reference.

### TECHNICAL FIELD

The present subject matter described herein, in general, relates to a field of Instant Messaging (IM) or chat messaging. More particularly, the present invention relates to a system and method to enable user interaction with one or more bots.

### BACKGROUND

Today, a variety of software applications facilitating chat messaging are available on personal computers, web, and mobile devices. These software applications enable a conversation amongst multiple users via a common platform. However, the conversation is often noisy and unstructured. For example, when multiple users such as 50 users reply to a chat message, it is hard to know what the collective response is. Conversations where subjective views evolve through the discussion add further to the confusion over the collective view at any given point in time. Often, a plurality of threads exists in the same conversation resulting in more confusion and incoherence. Some of the messages in the conversation may comprise of just a few words including slangs, unrecognized short forms, or expressive faces thereby making it difficult to understand the context of these messages in a conversation.

The incoherence rises exponentially in proportion to a group size. As the group size gets bigger, the number of messages and the amount of confusion get even more daunting to derive any conclusion from such conversations. This is the reason why most of the conventional chat systems limit the maximum number of people allowed in a group. Therefore, large organizations such as enterprises, government agencies, political parties, NGOs, or religious groups are unable to use the conventional chat systems for communication in large teams.

Let us use a few examples to illustrate the fallacies in conventional chat systems. Referring to FIG. 1, reactions of people on a poll using a conventional chat system are shown. Specifically, FIG. 1 shows a group that aims to determine a collective opinion by polling its members. However, the replies by the members in the group do not help to form any opinion due to the inherent unstructured format of the replies by the users in the group. Similarly, FIG. 2 shows sales tracking on a conventional chat system. In this example, a sales team aims to aggregate total sales of its members. However, the conventional chat systems receive random and unstructured replies which unfortunately do not help to come to any conclusion.

Moreover, messaging applications like Whatsapp™ have become very popular with mobile consumers. In most traditional implementations of messaging applications, end-users use their electronic devices such as smart phones or laptops for communicating with other users in their social network.

Messaging networks are now enabling software programs, not just human users, to send and receive messages through an application programming interface (API). A software program that can send and receive messages is called a bot. Though bots may appear like any other user on the messaging network, it is actually a software program. Bots communicate with human users and may assist them in a number of daily activities such as shopping, ordering food online, booking a taxi, banking, sending payments, operating IOT devices, and even stock trading. Bots are popular in messaging systems like Telegram and Slack. Bots interact with humans via chat messages. The simplest bots may be able to respond to specific keywords in messages sent to them. For example, a weather forecasting bot may respond to the message “weather San Francisco” with a message saying “sunny, 75 deg F.”.

More advanced bots may rely on Natural Language Processing (NLP) to understand and interpret the message sent to them. However, NLP involves significant amount of effort in deciphering context/language. In addition, the interpretation drawn by NLP can go wrong at times. NLP works even more poorly with non-English languages. So, NLP bots may not be able to understand the user request well enough to be able to adequately respond to the user's request. One of the solutions to address the issue of correctly capturing user instructions is by using Interactive Voice Response (IVR). However, implementing IVR is a tedious process as compared to NLP.

### SUMMARY

Before the present systems and methods are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods for monitoring one or more quality control activities to be performed during development of a software application and the concepts are further described below in the detailed description. This summary is not intended to identify essential features of the claimed subject matter nor is it intended for use in detecting or limiting the scope of the claimed subject matter.

In one implementation, a method for chat messaging between one or more user devices and one or more bots is disclosed. The method comprises creating a structured chat message by a bot of a user group, wherein the user group consist of one or more user devices and one or more bots, wherein the structured chat message comprises one or more data fields, and wherein the structured chat message comprises layout metadata defining a representation of the structured chat message; sending the structured chat message, to the user group, by the bot; and facilitating to display the structured chat message on the user devices using the layout metadata.

In another implementation, system for chat messaging between one or more user devices and one or more bots is disclosed. The system comprises: a processor; and a memory coupled to the processor, wherein the processor is capable for executing programmed instructions stored in the memory to: create a structured chat message by a bot of a user group, wherein the user group consist of one or more user devices and one or more bots, wherein the structured chat message comprises one or more data fields, and wherein the structured chat message comprises layout metadata defining a representation of the structured chat message; send the structured chat message, to the user group, by the bot; and facilitate to display the structured chat message on the user devices using the layout metadata.

In yet another implementation, a non-transitory computer readable medium embodying a program executable for chat messaging between user devices is disclosed. The non-transitory computer readable medium comprising: a program code for creating a structured chat message by a bot of a user group, wherein the user group consist of one or more user devices and one or more bots, wherein the structured chat message comprises one or more data fields, and wherein the structured chat message comprises layout metadata defining a representation of the structured chat message; a program code for sending the structured chat message, to the user group, by the bot; and a program code for facilitating to display the structured chat message on the user devices using the layout metadata.

### BRIEF DESCRIPTION OF THE DRAWINGS

The foregoing detailed description of embodiments is better understood when read in conjunction with the appended drawings. For the purpose of illustrating the disclosure, there is shown in the present document example constructions of the disclosure. However, the disclosure is not limited to the specific methods and apparatus disclosed in the document and the drawings.

The detailed description is described with reference to the accompanying figures. In the figures, the left-most digit(s) of a reference number identifies the figure in which the reference number first appears. The same numbers are used throughout the drawings to refer like features and components.

FIGS. 1 and 2 illustrate a conventional chat system in accordance with prior art.

FIG. 3 illustrates a network implementation of a system for chat messaging, in accordance with an embodiment of the present disclosure.

FIGS. 4a, 4b, and 4c jointly illustrate a structured chat message and it's updating, in accordance with an embodiment of the present disclosure.

FIGS. 5a, 5b, and 5c jointly illustrate a structured chat message posted by a bot on the user group for receiving user inputs for a poll and for a sales forecast, in accordance with an embodiment of the present disclosure.

FIGS. 6a, 6b, and 6c jointly illustrate a structured chat message and it's updating, in accordance with an embodiment of the present disclosure.

FIG. 7 illustrates an architecture used for structured chat messaging, in accordance with an embodiment of the present disclosure.

FIG. 8 illustrates a method for chat messaging between users devices, in accordance with an embodiment of the present disclosure.

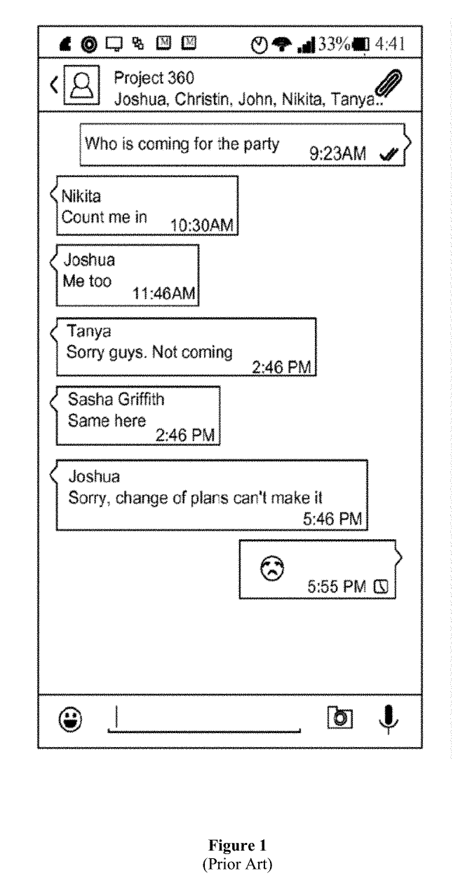

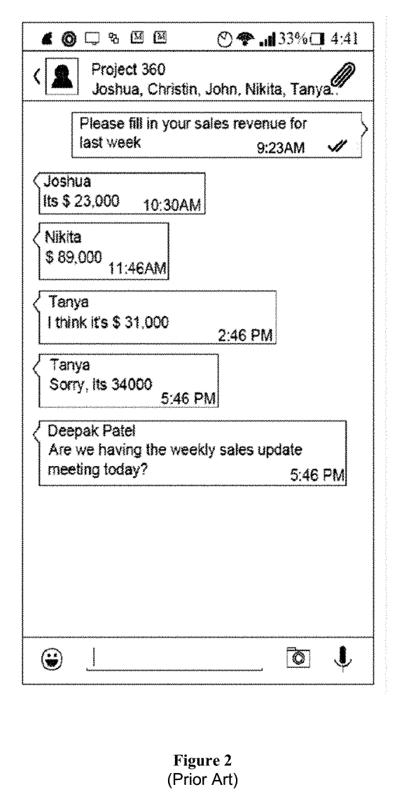

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

While aspects of described system and method for chat messaging between user devices may be implemented in any number of different computing systems, environments, and/or configurations, the embodiments are described in the context of the following exemplary system.

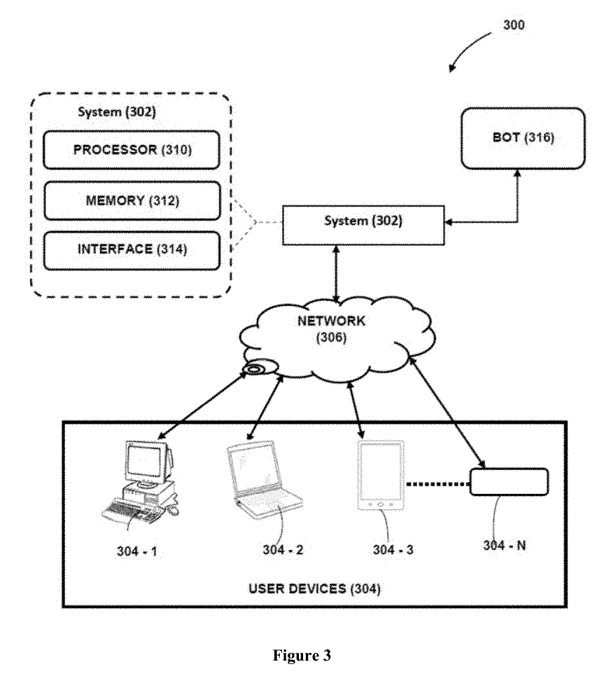

Referring now to FIG. 3, a network implementation 300 of a system 302 for chat messaging between one or more user devices 304 and one or more bots hereafter referred to as bot 316 is disclosed. The system 302 may be used for facilitating structured chat messages which dramatically reduce confusion and clutter in a group of several users. For example, consider that a structured chat message is initiated by a sales bot involved in sale of a certain product such as phones. The sales bot may have initiated the structured chat message to inquire about the number of products sold by each member of the team in a particular day or week. After sending the structured chat message to the team/user group, the structured chat message will receive inputs from all the team members. These inputs may be aggregated/updated by the system 302 so that there is no clutter and a conclusion may be derived out of such conversation. Specifically, in one example, the inputs may be aggregated to display a total number of phones sold by the team in a structured format. The system 302 or the chat messenger may further determine an average number of phones sold on each day of the week or a highest or lowest number of phones sold by a particular team member or may perform other mathematical operations on the inputs as desired by the leader. Similarly, the structured chat messages may be used for poll, sale, survey, nominating, location tracking, providing comments, maintaining a checklist, seeking information about something, announcing, and the like. Thus, in one embodiment, the server/system 302 may facilitate the chat service/messaging between the users.

The system 302 additionally comprises a bot application program interface (API) that can be used by bots to send and receive messages on the user group enabled by the system 302, wherein the system 302 is also configured to generate the user group containing one or more bots and one or more users. The bots 316 and the users interact by sending structured chat messages in the user group. Using the structured chat messages obviates the need for NLP by the bots in order to interpret the user queries and feedback. In addition, the structured chat message also solves the problems associated with NLP like bots mistakes in interpreting what users want.

Although the present subject matter is explained considering that the system 302 is implemented on a server, it may be understood that the system 302 may also be implemented in a variety of computing systems, such as a laptop computer, a desktop computer, a notebook, a workstation, a mainframe computer, a server, a network server, a cloud-based computing environment and the like. In one implementation, the system 302 may comprise the cloud-based computing environment in which the user may operate individual computing systems configured to execute remotely located applications. It will be understood that the system 302 may be accessed by multiple users through one or more user devices 304-1, 304-2 . . . 304-N, collectively referred to as user 304 hereinafter, or applications residing on the user devices 304. In one embodiment, the system 302 is configured to generate a user group for communication between the user devices 104. The user group may be in the form of a chatting group, wherein different users of the user devices 104 can communicate with each other and provide their feedback. In one embodiment, some of the user in the group maybe a bot applications. The bot applications may communicate with other users operating the user devices 104 through the system 302. The system 302 also enables an Application Program Interface (API) for interfacing a bot 316 to the user group. In one embodiment, the bot 316 is configured to generate a structured chat message to accept feedback from the users in the user group. It may also be understood that the chat messenger may also be implemented in the user devices 304 by adopting peer to peer architecture. Examples of the user devices 304 may include, but are not limited to, a portable computer, a personal digital assistant, a handheld device, and a workstation. The user devices 304 are communicatively coupled to the system 302 through a network 306.

In one implementation, the network 306 may be a wireless network, a wired network or a combination thereof. The network 306 can be implemented as one of the different types of networks, such as intranet, local area network (LAN), wide area network (WAN), the internet, and the like. The network 306 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 306 may include a variety of network devices, including routers, bridges, servers, computing devices, storage devices, and the like.

The system 302 is illustrated in accordance with an embodiment of the present disclosure. In one embodiment, the system 302 may include at least one processor 310, a memory 312, and an input/output (I/O) interface 314. The at least one processor 310 may be implemented as one or more microprocessors, microcomputers, microcontrollers, digital signal processors, central processing units, state machines, logic circuitries, and/or any devices that manipulate signals based on operational instructions. Among other capabilities, the at least one processor 310 is configured to fetch and execute computer-readable instructions stored in the memory 312.

The I/O interface 314 may include a variety of software and hardware interfaces, for example, a web interface, a graphical user interface, and the like. The I/O interface 314 may allow the system 302 to interact with the user directly or through the user devices 304 also hereinafter referred to as client devices 304. Further, the I/O interface 314 may enable the system 302 to communicate with other computing devices, such as web servers and external data servers (not shown). The I/O interface 314 can facilitate multiple communications within a wide variety of networks and protocol types, including wired networks, for example, LAN, cable, etc., and wireless networks, such as WLAN, cellular, or satellite. The I/O interface 314 may include one or more ports for connecting a number of devices to one another or to another server.

The memory 312 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, at first, a user may use the user devices 304 to access the system 302 via the I/O interface 314. The user may register them using the I/O interface 314 in order to use the system 302. In one embodiment, is to be registered with the system 302, the application program interface of the system 102 is configured to interface the bot 316 and register the bot 316 to the user group in the system 302. In one aspect, the user may access the I/O interface 314 of the system 302 for facilitating a chat service between user devices 304. The method for facilitating the chat messaging between the user devices 304 will be described henceforth.

In one embodiment, a user may operate a user device 304 to select a structured chat message from a group of structured chat messages pre-stored in the system 302 or in the user device. In another embodiment, the user may create a structured chat message on their own, over the user device 104. The user may be a human or a bot 316 registered to the user group enabled by the system 302. In one embodiment, the bot 316 may analyze a message posted on the user group and accordingly generated a structured message corresponding to the message in the user group. For example, a user in the user group may post a message “how may group members are available for a party on this weekend”. The bot 316 in the group may analyze this message and accordingly generate a structured chat message for seeking inputs of the members in the user group on confirm their availability on the weekend. The structured chat message may also aggregate the feedback received from the members of the user group and display it on the user group. The structured chat messages may be designed using at least one of a JavaScript Object Notation (JSON) format or an Extensible Stylesheet Language (XSL) format. The structured chat messages may be related to an area of business, entertainment, education, and others. In one embodiment, the system 302 may allow the user to create a structured chat message having a type and one or more data fields. The types of structured chat messages may include poll, sale, survey, nominating, location tracking, providing comments, maintaining a checklist, seeking information about something, announcing, and the like. The one or more data field may indicate a particular need of a user, initiating a structured chat message, on one of these types. The users may select a particular type of the structured chat message based upon their needs. In one embodiment, the structured chat message is configured to allow the user of the user group to approve or reject a request, select an option from a set of options, and fill a form. The form comprises one or more text fields, a password field, radio buttons, check boxes, a list of options, an image uploading option, a voice clip, a video file, a text file, an option for digitally applying the user's signature. In one embodiment, the structured chat message enabling the users to interact with the bots in the user group in a structure manner.

In one embodiment, the structured chat message may also comprise layout metadata defining a representation of the structured chat message. The layout metadata comprises visual position, sequence, and formatting of the data fields in the structured chat messages and hence defines the representation of the structured chat message. The visual position includes absolute or relative position of the data fields with respect to other elements of the layout. The formatting includes size, color, label, font, spacing and other visual elements.

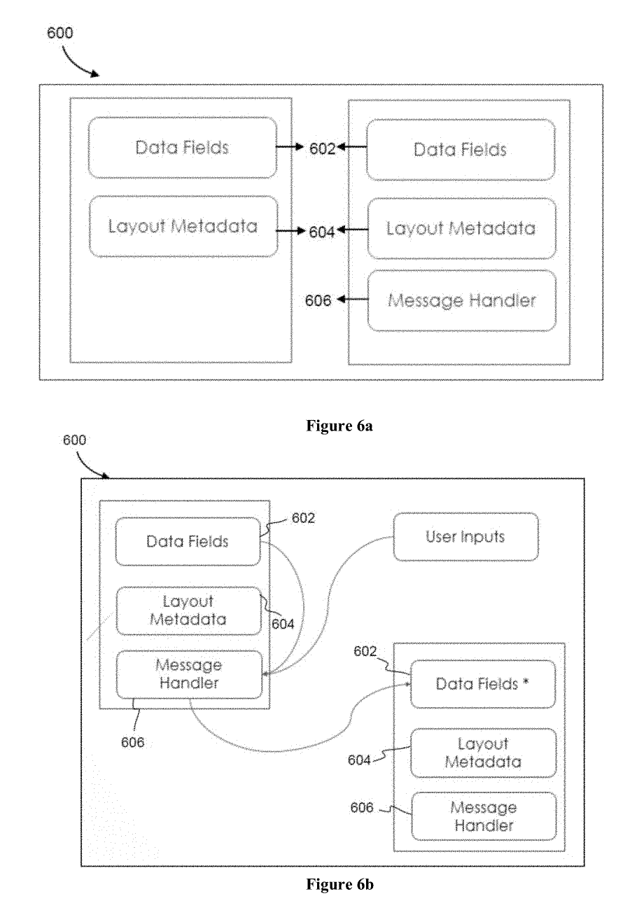

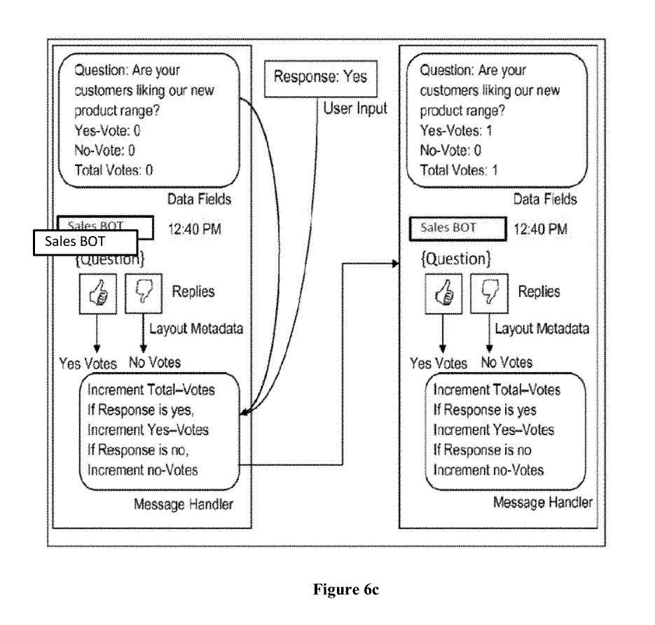

In another embodiment, the structured chat message may also comprise message handler. The message handler comprises software instructions that determine the updating of the structured chat message, explained in detail in FIGS. 6a, 6b, 6c.

After creation of the structured chat message, the user or the bot 316 may send the structured chat message to other users in a user group via the system 302 (interchangeably referred to as ‘server’) or through a peer to peer architecture. The user group may comprise the users and bots 316 registered into the user group. The user group may accommodate a several hundreds of the users unlike the conventional chat systems. Thus, sending the structured chat message to the user group signifies sending the structured chat message to each of the users registered with the user group.

After sending, the structured chat message may get displayed on the user devices 304 using the layout metadata. After that, the user device 304 may receive the inputs of the user for the one or more data fields. The structured chat message and user input are sent to the system 302. In one example, the system 302 may use the message handler to update the structured chat message based on such inputs.

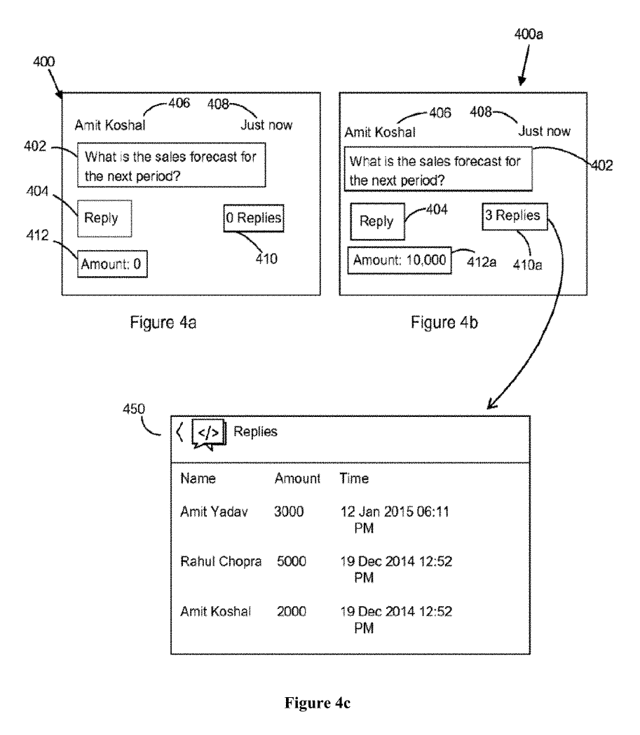

In order to illustrate the structured chat messages with an example, FIGS. 4a and 4b may be referred to. Specifically, in FIG. 4a, a structured chat message 400 is shown. In this example, the structured chat message 400 may be sent by the system 302 for determining a sales forecast of a team. Here, the team is equivalent in meaning to the users and bots 316 registered into the user group. In the example shown in FIG. 4a, the type of the structured chat message 400 pertains to determining a sale for a particular product. As shown, the structured chat message 400 may include a data field 402 i.e. “What is the Sales Forecast for the next period.” The structured chat message 400 may also comprise a ‘Reply’ tab 404 for allowing the users to provide inputs for the data field 402 of the chat. Further, the structured chat message 400 may also comprise a name 406 of the sender and a time 408 at which the message is sent by the user. Further, the structured chat message 400 may also comprise a “replies’ tab 410 indicating a total number of responses/inputs received by the system 302 from the users in that user group. The structured chat message 400 may further comprise an ‘Amount’ tab 412 indicating a quantified output depending on the inputs of the users.

In this example, the users may provide inputs for the data field 402 by selecting a reply tab 404. After selecting the reply tab 404, the user may be displayed a screen (not shown) where they can provide their inputs. Subsequently, the structured chat message 400 may be updated based on the inputs of the users. The updated structured chat message 400a may be sent and displayed to the user group.

FIG. 4b shows that the updated structured chat message 400a has three replies from the users who have answered to the question asked. Similarly, hundreds of users can reply by clicking on the reply tab 404 and submit their inputs. A summary on a number of updated replies 410a is shown in the updated structured chat message 400a. Similarly, the updated structured chat message 400a also shows an updated amount 412a which shows a sum of all inputs. It may be understood that in another embodiment, the updated amount 412a may also display an average of inputs, a difference of the inputs, a maximum or a minimum value among the inputs based upon a mathematical operation selected by the user while creating the structured chat message 400. Therefore, it may be understood that the updated structured chat message 400a may always show updated replies or inputs and the user or bots 316 need not manually perform the desired mathematical operation to calculate the amount as required by the conventional chat systems.

Referring now to FIG. 4c, a historical log 450 of all the replies/inputs of the users is shown, in accordance with an embodiment of the present disclosure. Specifically, a user may click on the updated replies tab 410a to generate the historical log 450. The clicking action of the user on the updated replies tab 410a may redirect the user to the historical log 450 which may include users' name, the inputs of the users for the one or more data fields, and timestamps associated with the inputs. The historical log 450 may have a graphical form or/and a tabular form.

Thus, structured chat messages solve the problems discussed earlier by dramatically reducing confusion and clutter. As multiple users reply, the structured chat message aggregates/updates the inputs giving a real-time update on a collective view. Structured chat messages update themselves and there are no new inputs displayed separately in the same conversation thread. In other words, there is only one message, constantly updating itself. Even when a plurality of threads exist in the same conversation, there will only be one structured message per thread. Even messages with short inputs get aggregated in the context of the structured chat message.

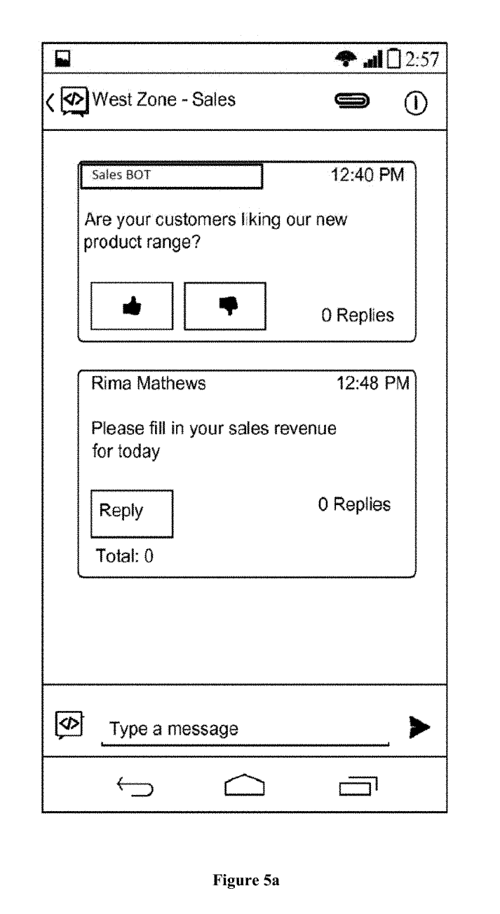

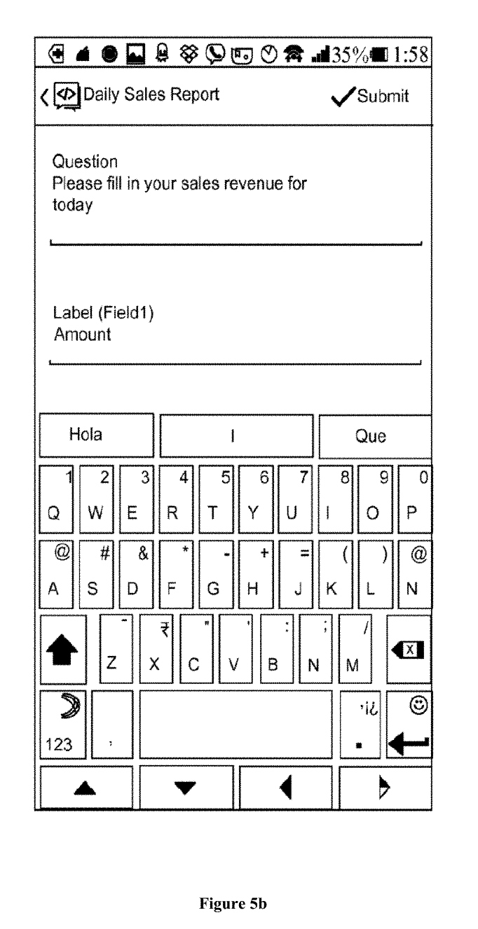

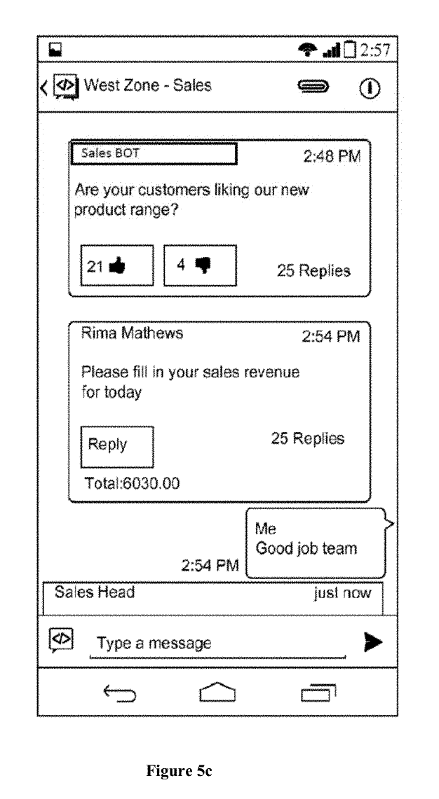

To illustrate, refer to FIG. 5a which shows two structured chat messages, a first thread pertaining to a poll i.e., “are your customers liking our new product range,” and a second thread pertaining to sales revenue, i.e., “please fill in your sales revenue for today.” The structured messages may be posted by a sales bot. For replying to the poll, the users in the user group may simply click on the thumb symbols to provide their inputs. Further, for replying to the sale revenue question, the users may click on the reply tab shown in FIG. 5b. After clicking on the reply tab, the users will be displayed the screen shown in FIG. 5b to key-in their inputs pertaining to the sales revenue. After the users have provided their inputs, the users will be displayed the screen shown in FIG. 5c with just two updated structured chat messages, hence reducing the clutter and memory consumption drastically. Thus, structured chat messages enable communications for teams of unlimited size. The number of messages in the conversation thread remain constant (just one message per thread) irrespective of the number of replies/inputs to it. The replies are aggregated instantly, so the collective responses are instantly displayed to every group member. Thus, it becomes very easy for large teams to communicate using the system 302.

Similarly, other types of structured chat messages for conducting survey, nominating, location tracking, providing comments, maintaining a checklist, seeking information about something, announcing, and the like may be used. Further, these structured chat messages are updated using message handlers explained below.

Referring now to FIGS. 6a, 6b, and 6c, a functioning of a message handler is illustrated in accordance with an embodiment of the present disclosure. Specifically, FIG. 6a shows a structured chat message 600 comprising a data field 602 (similar to the data field 402), a layout metadata 604, and a message handler 606 for updating the structured chat message. The message handler 606 comprises of software instructions that takes inputs submitted by the user to update the data fields 602 of the structured chat message 600 as shown in FIGS. 6a, 6b, and 6c. The update mechanism may be understood as aggregating the inputs of the users. The message handler 606 may aggregate the inputs of the users by applying certain mathematical operations on the inputs. The mathematical operations may include averaging, summing, differencing, and determining a highest/lowest value among the inputs, and the like.

In one example, the structured chat message may comprise of the following message handlers for updating the structured chat message based on the user inputs.

### Message Handler 1—Poll

A poll handler is a type of message handler which keeps a track of polls. While creating a poll, the user or the bot 316 may enter a question. The poll is displayed together with two buttons/tabs below it (corresponding to agree or disagree). When the respondents taps on any of the buttons, a response message is sent containing the details of the response. The poll message also has a button to view the individual replies together with summary statistics or the historical log regarding the options chosen.

### Message Handler 2—Numeric

A numeric handler is a type of message handler which allows keeping track of numeric data. While creating a numeric message, the user or the bot 316 may enter a question along with a label for the data that is required. The question is displayed together with a button/tab denoting reply. When the respondent taps on this, a form opens up showing the label (as entered by the user creating the message) together with a text field. The respondent can enter a numeric value here. The numeric message has a button to view the individual replies together with summary statistics or the historical log like sum, average etc.

### Message Handler 3—Comments

A comment handler is a type of message handler which allows keeping track of comments with other messages. In addition to a normal message, there is an extra button/tab called comment. When a respondent taps on it, a form opens up with a text field. The respondent can enter his comment here. The original message has a button to view the individual comments. Some comments (last comment; most common comment) may also be shown directly.

### Message Handler 4—Lookup

In one example, the user inputs may be used for querying and fetching data from a third party database. Specifically, a lookup handler may be used for looking up data from the web and/or the third party database. While creation, the look up handler may require some configuration regarding the data to be derived from the user, the URL from where to fetch the data, and a transformation to convert the data into a desired format. Once the configuration is complete, when the respondent taps on the lookup message from the menu, a form opens up with various parameters as defined in the configuration. The user fills these and send the message. While processing the message, the URL is created using the user entered data; the HTTP request is made to get the response and this is then converted into the desired format. The result is then displayed to the user. This can be used for various lookup mechanism like movie details, search query, item tracking, and the like.

### Message Handler 5—Data Entry

A data entry handler is a type of message handler which allows respondent to enter data as per pre-defined formats. While creating the form, the user enters the question together with details of the data to be collected as a list of items. While rendering this message, the question is displayed together with a reply button. When the respondent taps on this, a form opens up with a text field for each of the item in the list as created by the original user. The respondent can complete this form and submit. The original message also has a button to view the details of each of the responses.

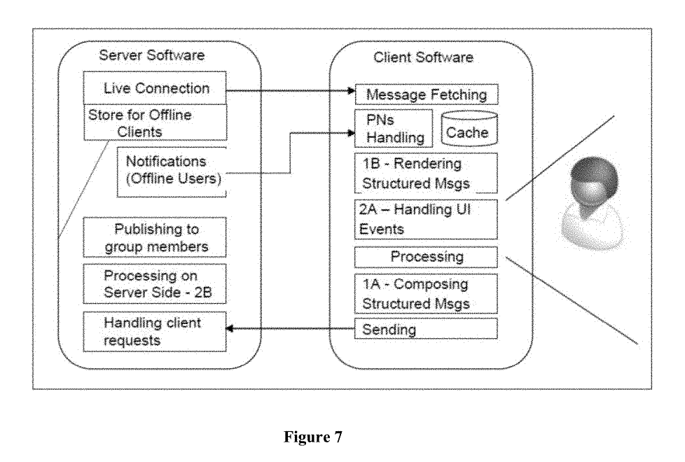

Referring now to FIG. 7, an architecture of a chat messaging system 302 is shown, in accordance with an embodiment of the present disclosure. The chat messaging system 302 consists of two distinct pieces of software; a client side software or the bot application program interface of the chat messaging system 302 and a server side software of the chat messaging system 302. The client side software or the bot application program interface is responsible to fetching the structured chat messages from the server, and optionally maintaining a cache on the client, notifying the user and rendering the structured chat messages as they arrive, composing and sending back structured chat messages composed by the user to the server. The clients have an additional functionality to interpret a message as a structured chat message and perform special handling of the same.

Server side software of the chat messaging system 302 is responsible for handling structured chat messages sent by a user or bot 316, deciding the recipients based on the group in which the structured chat message was sent, and optionally notifying the users about a new structured chat message and sending these structured chat messages to the users either via a live connection or later when the client software requests for the same. On the server side, there may be a hook that enables structured chat messages specific custom logic to be performed.

These processes are explained in detail in the following section.

### 1A. Composing a Structured Chat Message

### 1A.1—Opening a Menu

The user devices 304 have tabs for composing structured chat messages. When the user taps on the compose tab, a default form is shown. At times, there is requirement for dynamically changing the default form to be shown. In order to implement this, the user device 304 may periodically (once every 24 hours) ask the system 302 for the default form. If the form name has changed, it downloads the corresponding template and later uses this new template as the default form.

### 1A.2—Navigating the Menu

A menu is a User Interface (UI) element that is displayed when the user wishes to select the type of structured chat message to compose. Each menu has associated with it a template that defines how it should be rendered. The menu template is simple and consists of a list of items. Each item has a simple text name that is rendered and one of the following actions associated with it:
1. Begin composing a structured chat message
2. Directly submit a structured chat message to the server
3. Show another menu.

On clicking an item of type 1, the compose flow (1A.3) begins. On clicking type 2, a message is composed and sent to the server (1A.9). On clicking items of type 3, the current workflow (1A.2) is re-executed but with a different screen.

### 1A.3—Detecting Form Type

The element on which the user has clicked has underlying structure (in JSON format). This has a parameter that denotes that type of structured chat message that the user wishes to compose. This parameter is parsed out.

### 1A.4—Fetching the Form-json

Once the type of the structured chat message is detected, the client (interchangeably used as user device 304) searches locally for the same. If that type of structured chat message is unavailable, then it is downloaded from the server/system 302. The data corresponding to the type is in JSON format in the current implementation.

### 1A.5—Rendering

Once the form-j son is fetched, the client uses the same to render the composition screen. The form-j son typically has an array for fields. Each of these fields is displayed in a list fashion. Each field may be one of several field-types.

### 1A.6—Initial Values

Once the fields are created, they need to be populated with initial values. Initial values can come from two sources—the form-j son as well as the user-action data. The form-j son has the default values that are overridden by any values in the user-action data if present. For each field, the client decides which value should be used, executes a function if required and sets the result as the initial value.

### 1A.7—Validation

Data entry into forms often require data validation. These help ensure that invalid data is not entered by the users. If implemented at the point of data entry, these allow the quick detection of errors thus speeding up data entry enormously. Each form field can be associated with a list of validation rules. Each validation rule consists of a rule type, the rule, and an error message. Examples of rule types may include REGEX and FORMAT. For REGEX, the rule will consist of a regex string as per standard regex specifications. For FORMAT, the rule will similarly consist of a format string that can be used to parse dates, numbers etc.

When the user enters data for a data field and then removes focus from that data field, the validation rules are applied in sequence. For each validation rule, the system 302 checks if the data entered by the user matches the rule or not. If the rule does not match, the corresponding error message is shown to the user and the user is disallowed from proceeding to submit the form.

### 1A.8—Message Template

In anticipation of form submission, the client or the bot 316 can also create a message template. The message template consists of a JSON that is present as field in the form-j son. The values in this template may be overridden by the values in user action data. Further, the values for various data fields in this template may be pointers to the data fields in the rendered form screen. This message template is attached to form and awaits user submission.

### 1A.9—Message Template Updating

Once the user fills the form and taps submit, the message template needs to be updated to create the message. While some nodes in the template have the final values, others may refer to a fieldname. The values of these nodes are replaced by the data in the form screen.

1A.10—Message Sending

Once the structured chat message is properly updated, additional metadata like the group-name, the user sending the message and the timestamp is added and the structured chat message is sent to the server.

### 1B—Rendering a Structured Chat Message

### 1B.1—Structured Message Detection

The packets sent by a simple messaging utility have a certain structure. In addition to the text messages, these often have useful metadata regarding the message like the group name, the identity of the person who sent the message, the time when the message was sent etc. Implementing structured messaging requires the addition of one more item which denotes whether the message is simple (and should be handled as a simple text message) or whether it is a structured-message. Optionally, this information may not be used and all messages may be considered as structured-messages with simple text messages being a degenerate case. The client first parses this metadata and detect that the message in question is a structured message.

### 1B.2—Layout Metadata Extraction

After detecting that the message is a structured-message, the client extracts a field that denotes the layout metadata to be used. In the current implementation, layout metadata are references to XSL style-sheets giving HTML output.

### 1B.3—Fetching XSL Style-Sheets

Once the client gets the layout metadata, it searches locally for the associated XSL style-sheet. If it is unable to find it, it downloads the same from the server. In order to handle versioning the layout metadata, typically incorporates a version number.

### 1B.4—XML Conversion

Structured-messages have data fields. The data fields are in a custom JSON format. The custom JSON format has certain restrictions that ensure that the key names can be converted into a form that is a valid XML text. With this restriction, the data fields can be interconverted between XML and JSON forms at will. The client thus converts the structured message into the XML format.

### 1B.5—HTML Conversion

Once the client has the XSL style-sheet corresponding to the layout metadata and the structured-message as an XML, it applies standard XSLT transform to get the HTML from them.

### 1B.6—Updating Structured Messages

The client UI is capable of rendering each message in a HTML format. Once the message is converted to HTML as per the above step, the same is rendered in the UI.

### 1B.7—Updating Structured Messages

Structured messages often need to be updatable. This requirement is at cross purposes with the general architecture of messaging systems which usually assume that messages are immutable. In order to overcome this, each structured message is associated with the unique id called the form-id. Whenever the client receives a structured message in a group, it is required to remove all messages with the same form-id from that group before rendering the new message.

### 2A—Handling UI Events in Structured Chat Message

A structured message, when rendered, may have elements like buttons that enable interacting with it. In particular, they allow a user or the bot 316 to send replies to the message. These interactions are made possible by the general mechanism of creating a link for every item (like button) that needs to have some interaction behavior. Once created, these elements then allow the user to tap on them and get desired behavior. The whole process involves the following steps.

### 2A.1—Link Creation

There are client specific mechanisms for handling HTML links. Hence, while the HTML conversion is happening as per the previous flow, link objects are handled specially. This requires creating a handler to handle the link event, encoding all the data required to process the event into a client specific format, setting that data in the just created handler and attaching the handler to the link or button.

### 2A.2—Link Click Event Handling

When the user clicks on the link or button, the client software executes the message handler. The message handler has the encoded data which was set while creating it. This data includes a field that denotes the type of click-function to be used. The message handler then executes the appropriate click-function. The supported functions are
1. Sending a message
2. Showing a form
3. Displaying the message with a different xslt
4. Opening external links

### 2A.3—Sending a Message

In use cases like the poll, clicking on the “agree/disagree button” requires a message to directly be sent to the server (without showing a form in between). The handler decodes the encoded data (P3.2 above) to get a form template and a JSON containing final values. The flow is then switched to P1.9 with the JSON mocking the responses as entered by the user.

### 2A.4—Showing a Form

In use cases like the numeric form, clicking on the reply button requires the compose screen to be shown. The handler decodes the encoded data (P3.2 above) to get a form-json and json containing the user action data. The flow is then switched to P1.5 with these two fields.

2A.5—Displaying the Message with a Different xslt

In use cases like the details of people who replied to a poll, it is necessary to show the message with more details. The handler decodes the encoded data to get a reference to another xslt and uses this new xslt to render the same message in a new screen.

### 2A.6—Opening External Links

In use cases where the details are too numerous to be sent with the message every time, it may be necessary to fetch more details from the server. In order to support this, there is handler that supports opening external links. The base URL for the request is decoded from the encoded data and the request is signed by the user's credentials for authentication purposes. A request is then made to the server and the responses are displayed on the screen.

### 2B—Processing (Server Side)

### 2B.1—Message Handler Extraction

Each structured chat message comprises the message handler. The same is extracted by the server once the structured chat message reaches the server.

### 2B.2—Message Handler Instruction Set Selection

In one embodiment, for efficiency, software instructions (handler instructions) of the message handler may be stored on the server with the structured chat message comprising just a reference to the handler instructions rather than the handler instructions themselves. A number of handler instruction sets are registered with the server. For efficiency, different, but similar, message handlers may use the same handler instructions. Each handler instruction declares a list of message handlers that it handles. The server detects the handler instruction that is capable of the handling the structured chat message by matching the message handler present in the message with the message-handler-types registered by the various handler instructions.

### 2B.3—Custom Handling

Once the handler instructions are detected, the server gives the entire message payload for the custom handling to the handler instructions. Once the handling is complete, the handler instruction returns to zero or more messages (together with group-names) for sending to the recipients.

### 2B—Processing (Client Side)

Client side processing is similar to server side, however can be performed at two distinct phases. First, the processing can start immediately after the client receives a structured message or just after a structured message has been created but is yet to be sent to the server.

In either case, the steps are exactly the same as for server side processing. Thus, the system 302 may allow the user to facilitate a chat service between user devices 304 in the above described manner.

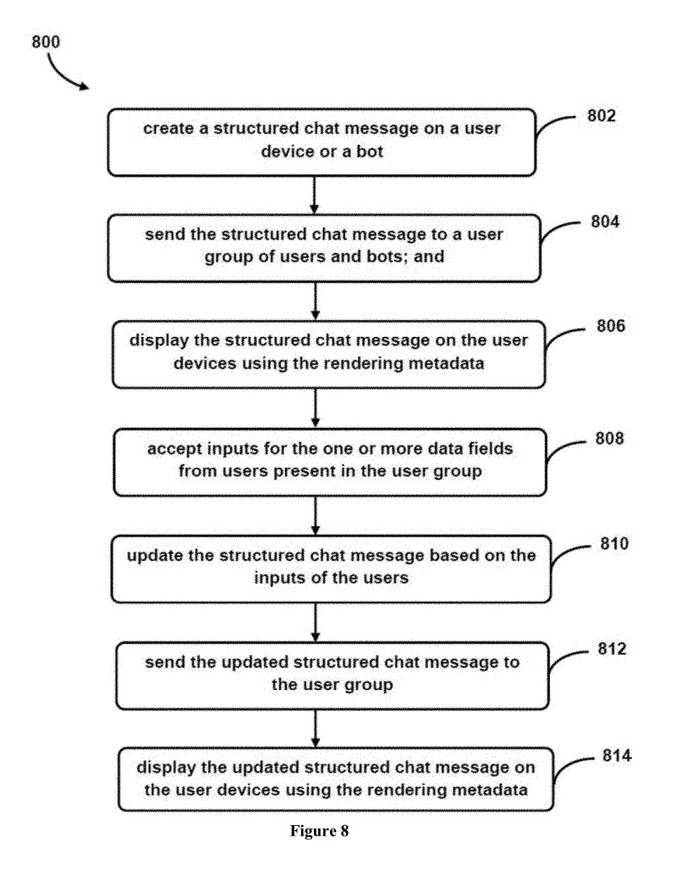

Referring now to FIG. 8, a method 800 for chat messaging between user devices 304 is shown, in accordance with an embodiment of the present disclosure. The method 800 may be described in the general context of computer executable instructions. Generally, computer executable instructions can include routines, programs, objects, components, data structures, procedures, modules, functions, etc., that perform particular functions or implement particular abstract data types. The method 800 may be practiced in a distributed computing environment where functions are performed by remote processing devices that are linked through a communications network. In a distributed computing environment, computer executable instructions may be located in both local and remote computer storage media, including memory 312 storage devices.

The order in which the method 800 is described is not intended to be construed as a limitation, and any number of the described method blocks can be combined in any order to implement the method 800 or alternate methods. Additionally, individual blocks may be deleted from the method 800 without departing from the spirit and scope of the disclosure described herein. Furthermore, the method can be implemented in any suitable hardware, software, firmware, or combination thereof. However, for ease of explanation, in the embodiments described below, the method 800 may be considered to be implemented in the above described in the system 302.

At block 802, a structured chat message may be created on a user device or at a bot associated with a user group in a social networking platform or a chatting application. The structured chat message comprises one or more data fields. The structured chat message may include layout metadata defining a representation of the structured chat message. At block 804, the structured chat message may be sent to the user group, by the bot. At block 806, the bot may facilitate to display the structured chat message on the user devices 304 using the layout metadata. At block 808, inputs for the one or more data fields may be accepted from users present in the user group. At block 810, the structured chat message may be updated based on the inputs of the users. At block 812, the updated structured chat message may be sent to the user group and also received by the bot. At block 814, the updated structured chat message may be displayed on the user devices 304 using the layout metadata. Further, the bot may perform different analytics operation in order to generate reports or makes suggestions to the users in the user group.

Although software instructions of methods and systems for structured chat messaging between users and bots have been described in language specific to structural features and/or methods, it is to be understood that the appended claims are not necessarily limited to the specific features or methods described. Rather, the specific features and methods are disclosed as examples of software instructions for structured chat messaging between user devices 304 and bots.

1. A method for chat messaging between user devices and one or more bots, the method comprising:
creating a structured chat message by a bot of a user group, wherein the user group consist of one or more user devices and one or more bots, wherein the structured chat message comprises one or more data fields, and wherein the structured chat message comprises layout metadata defining a representation of the structured chat message;
sending the structured chat message, to the user group, by the bot; and
facilitating to display the structured chat message on the user devices using the layout metadata.

2. The method of claim 1, wherein the structured chat message further comprises a message handler.

3. The method of claim 2, further comprising:
accepting inputs for the one or more data fields from users present in the user group;
updating the structured chat message using the message handler based on the inputs of the users;
sending the updated structured chat message to the user group; and
displaying the updated structured chat message on the user devices using the layout metadata.

4. The method of claim 3, wherein the updating comprises at least one of counting, averaging, summing, or differencing the inputs.

5. The method of claim 3, wherein the updating comprises determining a minimum or a maximum value among the inputs.

6. The method of claim 3, wherein the updating comprises querying and fetching data from a third party database based upon the inputs of the users.

7. The method of claim 3, wherein the structured chat message is used for at least one of conducting a poll, determining a sale of a team, conducting a survey, nominating, location tracking, providing comments, maintaining a checklist, announcing, or seeking information from the users.

8. The method of claim 3, further comprising displaying a historical log of the inputs of the users in a tabular form or a graphical form.

9. The method of claim 8, wherein the historical log comprises a users' name, the inputs of the users for the one or more data fields, and timestamps associated with the inputs.

10. The method of claim 1, wherein the structured chat message is created by the bot in response to a message over the user group, and wherein the one or more bots in the user group are configured to communicate with the user group through an application program interface.

11. The method of claim 1, wherein the structured chat message is configured to allow the user of the user group to approve or reject a request, select an option from a set of options, and fill a form.

12. The method of claim 11, wherein the form comprises one or more text fields, a password field, radio buttons, check boxes, a list of options, an image uploading option, a voice clip, a video file, a text file, an option for digitally applying the user's signature.

13. The method of claim 1, wherein the structured chat message enabling the users to interact with the bots in the user group.

14. A system for chat messaging between user devices and one or more bots, the system comprises:
a processor;
a memory coupled to the processor, wherein the processor is capable for executing programmed instructions stored in the memory to:
create a structured chat message by a bot of a user group, wherein the user group consist of one or more user devices and one or more bots, wherein the structured chat message comprises one or more data fields, and wherein the structured chat message comprises layout metadata defining a representation of the structured chat message;
send the structured chat message, to the user group, by the bot; and
facilitate to display the structured chat message on the user devices using the layout metadata.

15. The system of claim 14, wherein the structured chat message further comprises a message handler.

16. The system of claim 15, wherein the processor is further configured to:
accept inputs for the one or more data fields from users present in the user group;
update the structured chat message based on the inputs of the users;
send the updated structured chat message to the user group; and
display the updated structured chat message on the user devices using the layout metadata.

17. The system of claim 16, wherein the updating comprises at least one of counting, averaging, summing, or differencing the inputs.

18. The system of claim 16, wherein the updating comprises determining a minimum or a maximum value among the inputs.

19. The system of claim 16, wherein the updating comprises querying and fetching data from a third party database based upon the inputs of the users.

20. The system of claim 16, wherein the structured chat message is used for at least one of conducting a poll, determining a sale of a team, conducting a survey, nominating, location tracking, providing comments, maintaining a checklist, announcing, or seeking information from the users.

21. The system of claim 16, wherein the processor is further configured to display a historical log of the inputs of the users in a tabular form or a graphical form.

22. The system of claim 21, wherein the historical log comprises a users' name, the inputs of the users for the one or more data fields, and timestamps associated with the inputs.

23. A non-transitory computer readable medium embodying a program executable for chat messaging between user devices and one or more bots, the non-transitory computer readable medium comprising:
a program code for creating a structured chat message by a bot of a user group, wherein the user group consist of one or more user devices and one or more bots, wherein the structured chat message comprises one or more data fields, and wherein the structured chat message comprises layout metadata defining a representation of the structured chat message;
a program code for sending the structured chat message to the user group, by the bot; and
a program code for facilitation to display the structured chat message on the user devices using the layout metadata.
